(19) United States
(12) Patent Application Publication
(10) Pub. No.: US 2018/0264827 A1
(43) Pub. Date: Sep. 20, 2018

(54) CLEANING LIQUID FOR LIQUID EJECTING APPARATUS, LIQUID EJECTING APPARATUS, AND CLEANING METHOD FOR LIQUID CHANNEL

(71) Applicant: SEIKO EPSON CORPORATION, Tokyo (JP)

(72) Inventor: Shinichi YAMAMOTO, Matsumoto (JP)

(21) Appl. No.: 15/915,592

(22) Filed: Mar. 8, 2018

(30) Foreign Application Priority Data
Mar. 15, 2017 (JP) 2017-049696

(51) Int. Cl. B41J 2/165; C09D 9/00

(52) U.S. Cl. CPC B41J 2/16552; C09D 9/005; B41P 2235/14; B41P 2235/50; B41J 2002/16567

(57) ABSTRACT

A cleaning liquid for a liquid ejecting apparatus to be fed into liquid channels of a liquid ejecting apparatus contains at least a water-soluble organic solvent, a silicone surfactant, and an acetylenic diol surfactant. At least part of the inner surfaces of the liquid channels is made from a fluorine-based material.

### BACKGROUND

### 1. Technical Field

The present invention relates to a cleaning liquid for a liquid ejecting apparatus that is used to clean a liquid channel of the liquid ejecting apparatus, a liquid ejecting apparatus cleaned with the cleaning liquid, and a cleaning method for a liquid channel.

### 2. Related Art

Liquid ejecting apparatuses include liquid ejecting heads and eject various liquids from the liquid ejecting heads. Examples of such liquid ejecting apparatuses include image recording apparatuses, such as an ink jet printer and an ink jet plotter. Since an extremely small amount of a liquid can be precisely landed on a predetermined position, such liquid ejecting apparatuses are applied to various manufacturing apparatuses lately. For example, a liquid ejecting apparatus is applied to a display manufacturing apparatus for manufacturing a color filter of a liquid crystal display or the like; an electrode forming apparatus for forming an electrode of an organic electroluminescent (EL) display, a field emission display (FED), or the like; and a chip manufacturing apparatus for manufacturing a biochip (biochemical element). A recording head for the image recording apparatus ejects a liquid ink, whereas a coloring material ejecting head for the display manufacturing apparatus ejects solutions of respective coloring materials of red (R), green (G), and blue (B). Further, an electrode material ejecting head for the electrode forming apparatus ejects a liquid electrode material, whereas a biological organic matter ejecting head for the chip manufacturing apparatus ejects a solution of a biological organic matter.

Such a liquid ejecting head introduces ink or other liquids into pressure chambers from liquid supply sources, such as ink cartridges, via liquid channels and selectively drives piezoelectric elements or other actuators to eject droplets from nozzles communicated with the pressure chambers. There has been proposed a method in which a preservation solution is first introduced into a liquid ejecting head in the initial filling process where such liquid ejecting head is filled with a liquid to be ejected as droplets. The preservation solution is first introduced so that the liquid to be ejected as droplets is smoothly introduced, and then the liquid ejecting head is filled with the liquid to be ejected as droplets (see JP-A-2004-114647).

Even when such initial filling is performed as in JP-A-2004-114647, however, minute air bubbles may remain in the liquid channels. For example, when a preservation solution is introduced into a liquid ejecting head, air bubbles are generated in the liquid channels and remain in the liquid channels during the subsequent filling with a liquid. If air bubbles remain in the liquid channels, there is a risk of releasing air bubbles or air bubbles grown in the liquid channels during the liquid ejection operation after the initial filling, and resulting migration of air bubbles toward the nozzles. Accordingly, there is a risk of causing liquid ejection failure, such as missing dots in which droplets are not ejected from nozzles, or deflection in which droplets fail to land on predetermined positions. In particular, compared with printers in small sizes for office or household use that print on recording paper, photo paper, or the like, wide-format printers for printing posters and the like, as well as textile printers for printing on fabric, for example, have longer liquid channels from the ink cartridges to the nozzles, and therefore air bubbles are more likely to remain in liquid channels and the ejection failure of liquids is more likely to occur.

### SUMMARY

An advantage of some aspects of the invention is to provide a cleaning liquid for a liquid ejecting apparatus, the cleaning liquid being capable of reducing air bubbles remaining in a liquid channel, a liquid ejecting apparatus, and a cleaning method for a liquid channel.

According to a first aspect of the invention, a cleaning liquid for a liquid ejecting apparatus is a leaning liquid to be fed into a liquid channel of the liquid ejecting apparatus, and contains at least a water-soluble organic solvent, a silicone surfactant, and an acetylenic diol surfactant.

According to the aspect of the invention, antifoaming properties (specifically, effective suppression of growth of air bubbles and/or effective shrinkage or dissipation of air bubbles) can be enhanced by an acetylenic diol surfactant. In addition, surface tension can be lowered by a silicone surfactant, thereby enhancing wettability, i.e., dischargeability of air bubbles. Accordingly, migration of air bubbles toward nozzles can be suppressed after a cleaning liquid for a liquid ejecting apparatus is fed into a liquid channel, during initial filling with a liquid, and during the subsequent ejection of the liquid. Consequently, liquid ejection failure such as missing dots or deflection can be suppressed. As used herein, the expression “feeding a liquid” indicates not only allowing a liquid to flow, but also maintaining a state of being filled with the liquid, i.e., filling.

In the above configuration, at least part of the inner surface of the liquid channel is preferably made from a fluorine-based material.

According to this configuration, antifoaming properties and dischargeability of air bubbles can also be enhanced when the liquid channel is made from a fluorine-based material.

In any of the above configurations, an amount of dissolved nitrogen (N₂) is preferably 5 ppm or less.

According to this configuration, air bubbles remaining in the liquid channel can be reduced further.

A liquid ejecting apparatus according to a second aspect of the invention includes a liquid channel at least part of an inner surface of which is made from a fluorine-based material, in which a cleaning liquid for a liquid ejecting apparatus, the cleaning liquid containing at least a water-soluble organic solvent, a silicone surfactant, and an acetylenic diol surfactant, is fed into the liquid channel, and a state of the inner surface is modified.

According to the aspect of the invention, the inner surface of the liquid channel is modified into a state in which air bubbles are not likely to remain thereon, thereby further enhancing dischargeability of air bubbles.

In the above configuration, the liquid ejecting apparatus preferably further includes an ultrasonic vibration mechanism that applies ultrasonic vibration to a liquid in the liquid channel.

According to this configuration, ultrasonic vibration can be applied to a liquid in the liquid channel during the initial filling, and thus air bubbles remaining on a wall surface inside the liquid channel can be suppressed by the ultrasonic vibration.

According to a third aspect of the invention, a cleaning method for a liquid channel is a cleaning method for a liquid channel of a liquid ejecting apparatus, and includes feeding a cleaning liquid for a liquid ejecting apparatus, the cleaning liquid containing at least a water-soluble organic solvent, a silicone surfactant, and an acetylenic diol surfactant, into the liquid channel.

According to the aspect of the invention, antifoaming properties and dischargeability of air bubbles can be enhanced after cleaning of the liquid channel. Accordingly, migration of air bubbles toward nozzles is suppressed during the initial filling with a liquid and during the subsequent ejection of the liquid. As a result, liquid ejection failure such as missing dots or deflection can be suppressed.

In the above configuration, the liquid channel is preferably filled with the cleaning liquid for a liquid ejecting apparatus, and is left to stand at a temperature equal to or higher than room temperature for 30 minutes or longer.

According to this configuration, the inner surface of the liquid channel can be modified into a state in which air bubbles are not likely to remain thereon. Accordingly, dischargeability of air bubbles can be enhanced further.

In the above configuration, the liquid channel is preferably filled with the cleaning liquid for a liquid ejecting apparatus, and is left to stand at a temperature equal to or higher than 60° C. for 10 minutes or longer.

According to this configuration, the inner surface of the liquid channel can be modified into a state in which air bubbles are not likely to remain thereon. Accordingly, dischargeability of air bubbles can be enhanced further. In addition, the time for the modification can be shortened.

### BRIEF DESCRIPTION OF THE DRAWINGS

The invention will be described with reference to the accompanying drawings, wherein like numbers reference like elements.

FIG. 1 is a perspective view illustrating the internal structure of a printer.

FIG. 2 is a sectional view of the main part of a liquid ejecting unit.

### DESCRIPTION OF EXEMPLARY EMBODIMENTS

Hereinafter, embodiments of the invention will be described with reference to the accompanying drawings. Although the embodiments below are variously limited as preferable examples of the invention, the scope of the invention, unless otherwise indicated in the following description, should not be limited to the embodiments. An ink jet printer (hereinafter referred to as a printer) 1 equipped with an ink jet recording head (hereinafter referred to as a recording head) 3, which is a type of liquid ejecting head, will be described hereinafter as an example of the liquid ejecting apparatus of the invention.

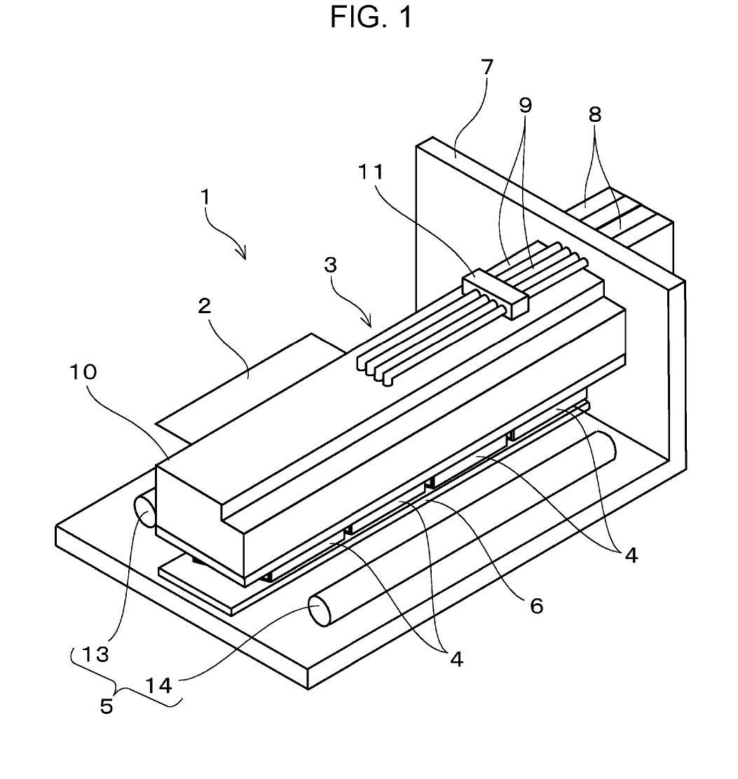

The configuration of the printer 1 will be described with reference to FIG. 1. The printer 1 is an apparatus that ejects ink, which is a type of liquid, onto the surface of a recording medium 2, such as recording paper or fabric, to record an image or the like. For example, the printer 1 includes, in an apparatus body 7, a recording head 3 equipped with a plurality of liquid ejecting units 4, a transport mechanism 5 that transports the recording medium 2, and a medium support 6 (also referred to as a platen) that supports the recording medium 2 transported to a position at which the recording medium 2 faces nozzle surfaces of the liquid ejecting units 4.

The recording head 3 of the embodiment is a line head in which a plurality (four in the embodiment) of the liquid ejecting units 4 are aligned and fixed to a holding member 10, which extends in the direction intersecting (in the embodiment, perpendicular to) the transport direction of the recording medium 2. Supply tubes 9, which communicate with the inside of ink cartridges 8 that store ink, are connected to this recording head 3. The supply tubes 9 of the embodiment are tubes made from a fluorine-based material (a fluororesin, for example). In other words, the inner surfaces of the supply tubes 9 are made from a fluorine-based material. Inks from the ink cartridges 8 are supplied to liquid channels (not shown) in the holding member 10 via the supply tubes 9 and introduced into liquid channels (specifically, liquid inlet paths 21 described hereinafter) in the liquid ejecting units 4 via the liquid channels. An ultrasonic vibration mechanism 11 that applies ultrasonic vibration to ink in the supply tubes 9 is fixed to the supply tubes 9 at intermediate positions. By driving the ultrasonic vibration mechanism 11, ultrasonic vibration can be applied to ink in the supply tubes 9, thereby suppressing retention of air bubbles or the like on the inner surfaces (wall surfaces) of the supply tubes 9. Also, air bubbles retained on the inner surfaces of the supply tubes 9 are readily released from the inner surfaces. Alternatively, a configuration in which ink cartridges are mounted on a recording head can also be employed. Further, a configuration in which an ultrasonic vibration mechanism is provided on channels in a recording head can also be employed.

The transport mechanism 5 includes first transport rollers 13 that are arranged as an upper/lower pair on the upstream side of the medium support 6 in the transport direction of the recording medium 2, and second transport rollers 14 that are arranged as an upper/lower pair on the downstream side of the medium support 6 in the transport direction. Upon driving of these transport rollers 13 and 14, the recording medium 2 from the supply side is moved on the medium support 6 while being pinched between the upper/lower rollers and is transported toward the ejection side. In FIG. 1, the upper-side rollers of the upper/lower pairs of the rollers are not illustrated. Alternatively, in some cases, a transport mechanism is formed of a seamless belt or a drum; and in this case, such a belt or a drum also functions as a medium support. Further, a medium support onto which a recording medium is caused to adhere with an electrostatic force or a negative pressure can also be employed.

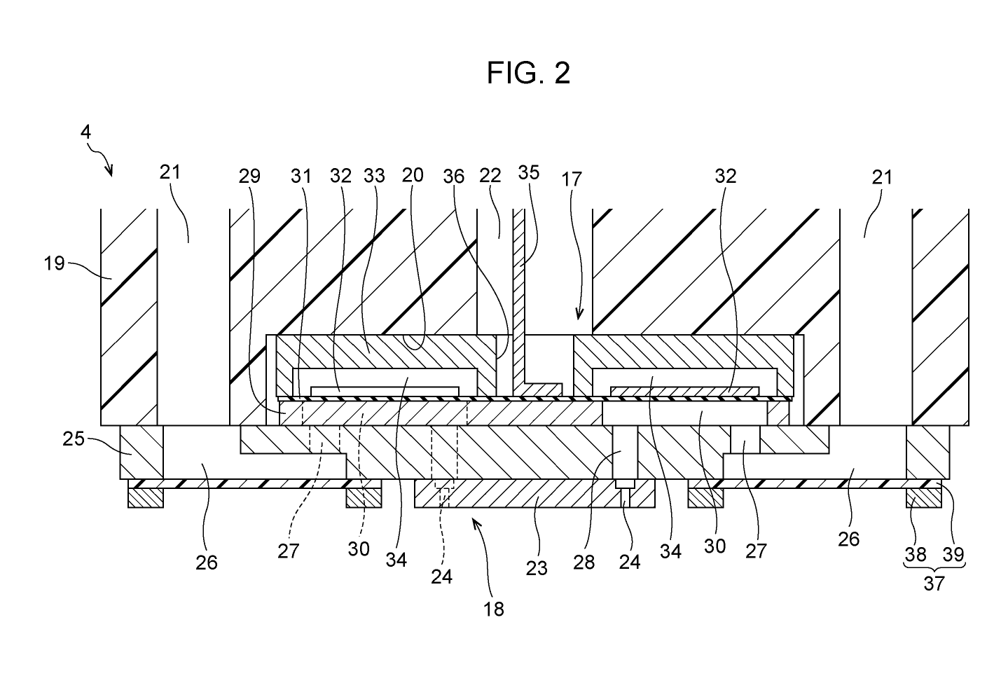

FIG. 2 is a sectional view of the main part of the liquid ejecting unit 4. The liquid ejecting unit 4 of the embodiment includes an actuator unit 17, a channel unit 18, and a head case 19, as illustrated in FIG. 2. In the following description, the stacking direction of each component will be described as the up/down direction.

The head case 19 of the embodiment is a box-like member made of synthetic resin and joined to the upper surface of the channel unit 18. As illustrated in FIG. 2, an actuator housing space 20 and a head case space 22 are formed in the central part of the head case 19. The actuator housing space 20 is a space for housing the actuator unit 17. The head case space 22 is a space communicating with the actuator housing space 20 and extending in the head case 19 in the thickness direction. In the head case space 22 and the actuator housing space 20, a flexible substrate 35 that provides driving signals to piezoelectric elements 32 (described hereinafter) is arranged. In the head case 19, liquid inlet paths 21 in which ink flows are formed. In the embodiment, two liquid inlet paths 21 are formed to correspond to nozzle rows that are formed as two rows.

The channel unit 18 of the embodiment is a substrate, which extends in the nozzle row direction and is formed by stacking a communication substrate 25, a nozzle plate 23, and a compliance substrate 37. Each substrate is bonded by using an adhesive (a silicone adhesive in the embodiment). The communication substrate 25 is a substrate having common liquid chambers 26 that communicate with the liquid inlet paths 21 and store an ink common to each pressure chamber 30, individual communicating paths 27 that supply ink from the common liquid chambers 26 to each pressure chamber 30, and nozzle communicating path 28 that causes the pressure chambers 30 and nozzles 24 to communicate with each other. The nozzle plate 23 is a substrate that is joined to the lower surface of the communication substrate 25 (i.e., the surface on the side opposite to the side on which a pressure chamber-forming substrate 29 is provided). The nozzle plate 23 of the embodiment is joined to the communication substrate 25 in a region between the two common liquid chambers 26 so as not to overlap the compliance substrate 37. In the nozzle plate 23, a plurality of nozzles 24 are provided linearly (in other words, in a row) in the longitudinal direction of the nozzle plate 23. The compliance substrate 37 is joined to a region corresponding to the common liquid chambers 26 in the communication substrate 25 and seals openings on the lower surface of the common liquid chambers 26. In the embodiment, the compliance substrate 37 includes a fixing substrate 38 made from a hard material, such as metal, and a sealing film 39 having low rigidity and flexibility and being stacked on the fixing substrate 38. In regions of the compliance substrate 37 facing the common liquid chambers 26, corresponding parts of the fixing substrate 38 are removed, leaving only the sealing film 39.

The actuator unit 17 of the embodiment is a composite substrate formed by stacking substrates, such as a pressure chamber-forming substrate 29, a diaphragm 31, and a sealing plate 33. The pressure chamber-forming substrate 29 is a substrate formed from a silicon single crystal substrate, for example, in which a plurality of pressure chambers 30 are provided and aligned in the nozzle row direction. The pressure chamber 30 is a space partitioned by the communication substrate 25 on the lower surface side and by the diaphragm 31 on the upper surface side and communicates with the individual communicating path 27 on one end and communicates with the nozzle communicating path 28 on the other end. The diaphragm 31 is a flexible thin-film member that is formed on the upper surface of the pressure chamber-forming substrate 29. The upper openings of the pressure chambers 30 are sealed by the diaphragm 31. In a region corresponding to each pressure chamber 30 (i.e., a driving region) in the upper surface (i.e., the surface of the diaphragm 31 on the side opposite to the side on which the pressure chamber-forming substrate 29 is provided) of the diaphragm 31 (specifically, an insulator film of the diaphragm 31), a piezoelectric element 32 is stacked. Upon driving of the piezoelectric element 32, the diaphragm 31 in the driving region is displaced away from or toward the nozzle 24. By utilizing changes in the volume of the pressure chambers 30 due to displacement, ink droplets are ejected from the nozzles 24 that communicate with the pressure chambers 30 via the nozzle communicating paths 28. The sealing plate 33 is a substrate having a piezoelectric element housing space 34 that houses the piezoelectric element 32, and a connecting space 36 into which the flexible substrate 35 is inserted. The sealing plate 33 is joined to the diaphragm 31 while the piezoelectric element 32 is housed in the piezoelectric element housing space 34.

Next, a cleaning liquid for a liquid ejecting apparatus used in the above-described printer 1 will be described. The cleaning liquid for a liquid ejecting apparatus is a liquid used for cleaning liquid channels in the printer 1 extending from the ink cartridges 8 to the nozzles 24, such as the supply tubes 9 and the liquid channels in the recording head 3. In particular, the cleaning liquid is used for cleaning the supply tubes 9 in the embodiment. Such a cleaning liquid for a liquid ejecting apparatus is fed into liquid channels during the manufacture of the printer 1 and/or immediately before initial filling with ink to clean inside the liquid channels. As used herein, the expression “feeding a liquid” indicates not only allowing a liquid to flow, but also maintaining a state of being filled with the liquid, i.e., filling. The cleaning liquid for a liquid ejecting apparatus can also be used as a preservation solution for filling the liquid channels of the printer 1 after the manufacture of the printer 1 until initial filling with ink is performed.

The cleaning liquid for a liquid ejecting apparatus of the invention contains at least a water-soluble organic solvent, a silicone surfactant, and an acetylenic diol surfactant. By incorporating both a silicone surfactant and an acetylenic diol surfactant into the cleaning liquid for a liquid ejecting apparatus, migration of air bubbles toward the nozzles can be suppressed during initial filling with ink and during the subsequent ejection of ink. This point will be described on the basis of the evaluation results of cleaning liquids for a liquid ejecting apparatus described hereinafter. The purpose of using the water-soluble organic solvent is to suppress drying of the cleaning liquid in liquid channels, and the water-soluble organic solvent is preferably readily miscible with ink. The same water-soluble organic solvent contained in ink used in the printer 1 can also be used as the solvent for the cleaning liquid. Examples of such water-soluble organic solvent include polyhydric alcohols, polyhydric alcohol alkyl ethers, polyhydric alcohol aryl ethers, N-heterocyclic compounds, amides, amines, sulfur-containing compounds, propylene carbonate, ethylene carbonate, and mixtures thereof.

The acetylenic diol surfactant is used mainly for enhancing antifoaming effects. Examples of the acetylenic diol surfactant include acetylenic diols and acetylenic diol-alkylene oxide adducts, and specifically, 2,5-dimethyl-3-hexyne-2,5-diol, 3,6-dimethyl-4-octyne-3,6-diol, 2,4,7,9-tetramethyl-5-decyne-4,7-diol, an alkylene oxide adduct thereof, and mixtures thereof. Meanwhile, the silicone surfactant is used mainly for enhancing dischargeability of air bubbles. Examples of the silicone surfactant include polysiloxane compounds, polyether-modified organosiloxanes, and mixtures thereof. In general, a silicone surfactant has a lower surface tension than an acetylenic diol surfactant. Accordingly, by incorporating a silicone surfactant into a cleaning liquid for a liquid ejecting apparatus containing an acetylenic diol surfactant, the surface tension of the cleaning liquid for a liquid ejecting apparatus can be lowered.

In addition to a water-soluble organic solvent, a silicone surfactant, and an acetylenic diol surfactant, other additives, such as an antiseptic/fungicide, a chelating agent, an anticorrosive agent, a pH modifier, and a penetrant, can also be added as desired to the cleaning liquid for a liquid ejecting apparatus. Such other additives are preferably the same components as those contained in ink.

Next, the evaluations of ink ejection failure when cleaning liquids for a liquid ejecting apparatus are used will be described with reference to Tables 1 to 3. The cleaning liquids for a liquid ejecting apparatus were evaluated by changing the contents of a silicone surfactant and an acetylenic diol surfactant, and the degree of degassing while other components were set to be the same (Table 1). The evaluation was also performed by changing the sequence and the mechanisms of the printer 1, for example (Table 2). Further, the evaluation was performed by changing the cleaning method of liquid channels (in the embodiment, the supply tubes 9) (Table 3). Hereinafter, room temperature indicates 25° C.

In the embodiment, after a cleaning liquid for a liquid ejecting apparatus was fed (filling included) into the supply tubes 9 to clean the supply tubes 9, the supply tubes 9 were installed in the printer 1 while the cleaning liquid for a liquid ejecting apparatus remained in the supply tubes 9, and the evaluation was performed. The evaluation was performed by filling the supply tubes 9 with ink used in the printer 1 while the cleaning liquid for a liquid ejecting apparatus remained in the supply tubes 9 (i.e., initial filling), immediately performing a flushing operation, and performing a printing operation, i.e., ejection of ink (evaluation during the initial filling). Further, after 24 hours had elapsed after the initial filling, a flushing operation was performed, and a printing operation, i.e., ejection of ink, was performed (evaluation after the filling/standing). If air bubbles remain during filling with ink, the time for the air bubbles to grow and cause missing dots is assumed to be 12 hours or longer. Accordingly, in the Examples, the evaluation after filling/standing was performed after 24 hours had elapsed. The flushing operation herein indicates an operation to eject ink from the nozzles 24 in a region other than the printing region. In a single flushing operation (1 seg), one or more ink droplets are ejected.

In Example 1, the evaluation during the initial filling and the evaluation after the filling/standing were performed by feeding a cleaning liquid for a liquid ejecting apparatus containing 0.2% by mass of an acetylenic diol surfactant, 0.45% by mass of a silicone surfactant, and 12.0 ppm of dissolved nitrogen (N₂) into the supply tubes 9 and then installing the supply tubes 9 in the printer 1. In the evaluation, the flushing operation was set to 216 seg. Further, in Example 1, no cleaning operation was performed, and neither the ultrasonic vibration mechanism 11 nor an air bubble trapping mechanism was used.

In Example 2, a cleaning liquid for a liquid ejecting apparatus containing 0.2% by mass of an acetylenic diol surfactant, 0.45% by mass a silicone surfactant, and 5.0 ppm of dissolved nitrogen (N₂) was used. In other words, the cleaning liquid of Example 2 is the same as the cleaning liquid for a liquid ejecting apparatus of Example 1 except for a lower degree of degassing. Since other conditions are the same as those for Example 1, description thereof will be omitted.

In Example 3, the flushing operation preceding the printing operation was set to 72 seg. Since other conditions are the same as those for Example 1, description thereof will be omitted.

In Example 4, a timer cleaning operation was performed after the filling/standing and before the printing operation. The timer cleaning operation herein indicates a cleaning operation that is performed after a predetermined time since filling in accordance with a setting of a timer. In Example 4, the cleaning operation was set to be performed once after the initial filling and until the printing operation after the filling/standing was performed (in the embodiment, 12 hours after the initial filling). The cleaning operation herein indicates an operation to discharge, by force, ink from each nozzle 24 by pressurizing the liquid channels in the recording head 3 or by sucking ink from the nozzles 24 side. Since other conditions are the same as those for Example 1, description thereof will be omitted.

In Example 5, the ultrasonic vibration mechanism 11 was used during the initial filling. In other words, ultrasonic vibration was applied to the supply tubes 9 during the filling with ink, thereby reducing retained air bubbles in the supply tubes 9. Since other conditions are the same as those for Example 1, description thereof will be omitted.

In Example 6, an air bubble trapping mechanism (not shown) was added in the liquid channels of the recording head 3. For example, the air bubble trapping mechanism is a mechanism for trapping air bubbles that enter the liquid channels, and includes, on the upstream side of the liquid ejecting unit 4, a finely meshed filter and a filter chamber in which the filter is disposed. Although a typical printer includes a filter, the air bubble trapping mechanism mentioned herein includes an additional filter or the like added to the liquid channels, in addition to such a typical filter. Since other conditions are the same as those for Example 1, description thereof will be omitted.

Examples 7 to 11 were evaluated by maintaining the supply tubes 9 filled with cleaning liquids for a liquid ejecting apparatus at a predetermined temperature for a predetermined time using a thermostatic bath, for example, and then installing the supply tubes 9 in the printer 1.

In Example 7, the supply tubes 9 were filled with the same cleaning liquid for a liquid ejecting apparatus as in Example 1 and were left to stand at room temperature for 10 minutes. Since other conditions are the same as those for Example 1, description thereof will be omitted.

In Example 8, the supply tubes 9 were filled with the same cleaning liquid for a liquid ejecting apparatus as in Example 1 and were left to stand at room temperature for 30 minutes. Since other conditions are the same as those for Example 1, description thereof will be omitted.

In Example 9, the supply tubes 9 were filled with the same cleaning liquid for a liquid ejecting apparatus as in Example 1, and were left to stand at room temperature for 180 minutes. Since other conditions are the same as those for Example 1, description thereof will be omitted.

In Example 10, the supply tubes 9 were filled with the same cleaning liquid for a liquid ejecting apparatus as in Example 1, and were left to stand at 60° C. for 10 minutes. Since other conditions are the same as those for Example 1, description thereof will be omitted.

In Example 11, the supply tubes 9 were filled with the same cleaning liquid for a liquid ejecting apparatus as in Example 1, and were left to stand at 60° C. for 180 minutes. Since other conditions are the same as those for Example 1, description thereof will be omitted.

In Comparative Example 1, a cleaning liquid for a liquid ejecting apparatus containing 1.0% by mass of an acetylenic diol surfactant, 0% by mass (i.e., absent) of a silicone surfactant, and 12.0 ppm of dissolved nitrogen (N₂) was used. Since other conditions are the same as those for Example 1, description thereof will be omitted.

In Comparative Example 2, a cleaning liquid for a liquid ejecting apparatus containing 0.2% by mass of an acetylenic diol surfactant, 0% by mass (i.e., absent) of a silicone surfactant, and 12.0 ppm of dissolved nitrogen (N₂) was used. Since other conditions are the same as those for Example 1, description thereof will be omitted.

In Comparative Example 3, a cleaning liquid for a liquid ejecting apparatus containing 0% by mass (i.e., absent) of an acetylenic diol surfactant, 0.45% by mass of a silicone surfactant, and 12.0 ppm of dissolved nitrogen (N₂) was used. Since other conditions are the same as those for Example 1, description thereof will be omitted.

As the evaluation criteria, the case in which the proportion of the nozzles that experience ejection failure (defective nozzles), such as missing dots in which droplets are not ejected from the nozzles 24, or deflection in which droplets fail to land on predetermined positions, is 0% based on the total number of the nozzles was set to “A”. The case in which the proportion of defective nozzles is more than 0% and 1.25% or less based on the total number of the nozzles was set to “B”, and the case in which the proportion of defective nozzles is more than 1.25% and 2.5% or less based on the total number of the nozzles was set to “C”. Further, the case in which the proportion of defective nozzles is more than 2.5% and 12.5% or less based on the total number of the nozzles was set to “D”, and the case in which the proportion of defective nozzles is more than 12.5% based on the total number of the nozzles was set to “E”.

TABLE 1

| | | | Example | Example | Comparative | Comparative | Comparative |
|---|---|---|---|---|---|---|---|
| Item | | | 1 | 2 | Example 1 | Example 2 | Example 3 |
| Cleaning | Acetylenic diol surfactant | [wt %] | 0.2 | 0.2 | 1.0 | 0.2 | 0 |
| liquid | Silicone surfactant | [wt %] | 0.45 | 0.45 | 0 | 0 | 0.45 |
| | Degree of degassing | [ppm] | 12.0 | 5.0 | 12.0 | 12.0 | 12.0 |
| | (N₂ value) | | | | | | |
| Cleaning | Filling/standing time | [min] | 0 | 0 | 0 | 0 | 0 |
| method | Filling/standing | [° C.] | 25 | 25 | 25 | 25 | 25 |
| | temperature | | | | | | |
| Printer | Flushing before start of | [seg] | 216 | 216 | 216 | 216 | 216 |
| | printing | | | | | | |
| | Timer cleaning | done/ | none | none | none | none | none |
| | | none | | | | | |
| | Ultrasonic vibration | present/ | absent | absent | absent | absent | absent |
| | mechanism | absent | | | | | |
| | Air bubble trapping | present/ | absent | absent | absent | absent | absent |
| | mechanism | absent | | | | | |
| Evaluation | During initial filling | — | A | A | C | C | B |
| result | After filling/standing | — | C | B | E | E | D |

TABLE 2

| Item | | | Example 3 | Example 4 | Example 5 | Example 6 |
|---|---|---|---|---|---|---|
| Cleaning | Acetylenic diol surfactant | [wt %] | 0.2 | 0.2 | 0.2 | 0.2 |
| liquid | Silicone surfactant | [wt %] | 0.45 | 0.45 | 0.45 | 0.45 |
| | Degree of degassing | [ppm] | 12.0 | 12.0 | 12.0 | 12.0 |
| | (N₂ value) | | | | | |
| Cleaning | Filling/standing time | [min] | 0 | 0 | 0 | 0 |
| method | Filling/standing | [° C.] | 25 | 25 | 25 | 25 |
| | temperature | | | | | |
| Printer | Flushing before start of | [seg] | 72 | 216 | 216 | 216 |
| | printing | | | | | |
| | Timer cleaning | done/ | none | done | none | none |
| | | none | | | | |
| | Ultrasonic vibration | present/ | absent | absent | present | absent |
| | mechanism | absent | | | | |
| | Air bubble trapping | present/ | absent | absent | absent | present |
| | mechanism | absent | | | | |
| Evaluation | During initial filling | — | A | A | A | A |
| result | After filling/standing | — | B | B | B | B |

TABLE 3

| | | | Example | Example | Example | Example | Example |
|---|---|---|---|---|---|---|---|
| Item | | | 7 | 8 | 9 | 10 | 11 |
| Cleaning | Acetylenic diol surfactant | [wt %] | 0.2 | 0.2 | 0.2 | 0.2 | 0.2 |
| liquid | Silicone surfactant | [wt %] | 0.45 | 0.45 | 0.45 | 0.45 | 0.45 |
| | Degree of degassing | [ppm] | 12.0 | 12.0 | 12.0 | 12.0 | 12.0 |
| | (N₂ value) | | | | | | |
| Cleaning | Filling/standing time | [min] | 10 | 30 | 180 | 10 | 180 |
| method | Filling/standing | [° C.] | 25 | 25 | 25 | 60 | 60 |
| | temperature | | | | | | |
| Printer | Flushing before start of | [seg] | 216 | 216 | 216 | 216 | 216 |
| | printing | | | | | | |
| | Timer cleaning | done/ | none | none | none | none | none |
| | | none | | | | | |
| | Ultrasonic vibration | present/ | absent | absent | absent | absent | absent |
| | mechanism | absent | | | | | |
| | Air bubble trapping | present/ | absent | absent | absent | absent | absent |
| | mechanism | absent | | | | | |
| Evaluation | During initial filling | — | A | A | A | A | A |
| result | After filling/standing | — | C | A | A | A | A |

As shown in Table 1, Comparative Examples 1 and 2, in which only an acetylenic diol surfactant was contained as a surfactant in the cleaning liquid for a liquid ejecting apparatus, were rated C in the evaluation during the initial filling and E in the evaluation after the filling/standing. This is presumably because air bubbles remaining in the supply tubes 9 were released and migrated toward the nozzles 24 after the initial filling, thereby increasing the number of defective nozzles. Further, the result of the evaluation after the filling/standing presumably worsened, compared with the result of the evaluation during the initial filling since minute air bubbles may grow over time, and the enlarged air bubbles migrate toward the nozzles 24 in response to the flushing operation. In Comparative Example 3, in which only a silicone surfactant was contained as a surfactant in the cleaning liquid for a liquid ejecting apparatus, the surface tension of the cleaning liquid for a liquid ejecting apparatus was presumably lowered compared with that in Comparative Examples 1 and 2, in which only an acetylenic diol surfactant was contained. Consequently, wettability, i.e., dischargeability of air bubbles, was presumably enhanced, thereby suppressing air bubbles remaining in the supply tubes 9. For this reason, Comparative Example 3 was rated B in the evaluation during the initial filling and D in the evaluation after the filling/standing, and thus the rating was better than in Comparative Examples 1 and 2. Comparative Example 3, however, remained unsatisfactory since the evaluation after the filling/standing was rated D.

In contrast, Example 1, in which both an acetylenic diol surfactant and a silicone surfactant were contained, was rated A in the evaluation during the initial filling and C in the evaluation after the filling/standing, and thus the rating was better than in Comparative Example 3. Antifoaming properties (specifically, effective suppression of growth of air bubbles and/or effective shrinkage or dissipation of air bubbles) can be enhanced by an acetylenic diol surfactant while surface tension is lowered, and thus wettability, i.e., dischargeability of air bubbles can be enhanced by a silicone surfactant. Accordingly, air bubbles remaining in the supply tubes 9 are presumably further suppressed. Accordingly, migration of air bubbles toward the nozzles 24 can be suppressed after the cleaning liquid for a liquid ejecting apparatus is fed into the supply tubes 9 during the initial filling with ink or during the subsequent ejection of ink. Liquid ejection failure, such as missing dots or deflection, can thus be suppressed. In Example 2, in which the degree of degassing of the cleaning liquid for a liquid ejecting apparatus was lowered, air bubbles presumably dissolved more readily in the cleaning liquid for a liquid ejecting apparatus, thereby facilitating dissipation of air bubbles. Consequently, Example 2 was rated A in the evaluation during the initial filling and B in the evaluation after the filling/standing, and thus the rating was better than in Example 1.

Example 3 was also rated A in the evaluation during the initial filling and B in the evaluation after the filling/standing, and thus the rating was better than in Example 1. This is presumably because the amount of discharged ink was reduced and the movement of air bubbles toward the nozzles 24 from the supply tubes 9 was suppressed due to the decreased frequency of the flushing operation preceding the printing operation, compared with the frequency of the flushing operation in Example 1 (in Example 3, the flushing operation after sufficient time had passed after the initial filling). Air bubbles in liquid channels tend to decrease after sufficient time has passed. Accordingly, the frequency of the flushing operation is preferably changed in accordance with the time that has elapsed since the initial filling. For example, when the time that has elapsed since the initial filling is 0 to 24 hours or shorter, the flushing operation preceding the printing operation is set to 72 seg. When the time is longer than 24 hours and 72 hours or shorter, the flushing operation preceding the printing operation is set to 144 seg. Further, when the time is longer than 72 hours, the flushing operation preceding the printing operation is set to 216 seg, which is the same as the flushing operation preceding the printing operation in other Examples. By performing such settings, the movement of air bubbles from the supply tubes 9 toward the nozzles 24 can be suppressed. At the same time, a thickened ink can be discharged from the nozzles 24.

Further, Examples 4 to 6 were also rated A in the evaluation during the initial filling and B in the evaluation after the filling/standing, and the rating was better than in Example 1. In Example 4, the number of defective nozzles presumably decreased since a large amount of ink was able to be discharged by the cleaning operation, thereby also discharging air bubbles in the supply tubes 9 together with ink. In Example 5, the number of defective nozzles presumably decreased since retention of air bubbles in the supply tubes 9 was able to be suppressed by application of ultrasonic vibration to the supply tubes 9 during the filling with ink. In Example 6, entry of air bubbles into the liquid ejecting units 4 was presumably able to be suppressed since the air trapping mechanism can trap air bubbles in the liquid channels. Accordingly, the number of defective nozzles was presumably reduced.

Example 7 was rated A in the evaluation during the initial filling and C in the evaluation after the filling/standing, and thus the rating was not improved as compared to Example 1. In other words, filling the supply tubes 9 with a cleaning liquid for a liquid ejecting apparatus and allowing to stand at room temperature for only 10 minutes was ineffective for realizing the advantages due to filling of the supply tubes 9 with a cleaning liquid for a liquid ejecting apparatus and allowing to stand. As shown in Examples 8 and 9, however, when the supply tubes 9 were filled with a cleaning liquid for a liquid ejecting apparatus and left to stand at room temperature for 30 minutes or longer, dramatic improvements were observed, as indicated by the rating of A in the evaluation during the initial filling and A in the evaluation after the filling/standing. Further, as shown in Examples 10 and 11, when the supply tubes 9 were filled with a cleaning liquid for a liquid ejecting apparatus and left to stand at 60° C. for 10 minutes or longer, dramatic improvements were also observed, as indicated by the rating of A in the evaluation during the initial filling and A in the evaluation after the filling/standing.

The analysis of the supply tubes 9 in Examples 8 to 11 has revealed that the state of the inner surfaces of the supply tubes 9 were modified. Specifically, although detailed molecular structures were unable to be identified, a silicone surfactant was found to be mainly adhere to the inner surfaces of the supply tubes 9. A silicone surfactant that adheres to the inner surfaces of the supply tubes 9 presumably enhances wettability of the inner surfaces of the supply tubes 9 to ink, thereby further enhancing dischargeability of air bubbles. Therefore, air bubbles remaining in the supply tubes 9 are presumably further suppressed, and thus ejection failure of ink due to air bubbles in liquid channels during the initial filling with ink and during the subsequent ejection of ink is presumably suppressed further.

As in the foregoing, since at least a water-soluble organic solvent, a silicone surfactant, and an acetylenic diol surfactant are contained in a cleaning liquid for a liquid ejecting apparatus used for the liquid channels of the printer 1, especially for the supply tubes 9, antifoaming properties and dischargeability of air bubbles can be enhanced. Accordingly, migration of air bubbles toward the nozzles 24 can be suppressed after feeding a cleaning liquid for a liquid ejecting apparatus into the supply tubes 9 during the initial filling with ink and during the subsequent ejection of ink. Accordingly, ejection failure such as missing dots or deflection can be suppressed. Meanwhile, the amount of nitrogen (N₂) dissolved in a cleaning liquid for a liquid ejecting apparatus is preferably 5 ppm or less. Such an amount of dissolved nitrogen can further reduce air bubbles remaining in liquid channels.

Further, it is preferable to modify the state of the inner surfaces of the supply tubes 9 by feeding a cleaning liquid for a liquid ejecting apparatus containing at least a water-soluble organic solvent, a silicone surfactant, and an acetylenic diol surfactant into the supply tubes 9. In other words, it is preferable to fill the supply tubes 9 with a cleaning liquid for a liquid ejecting apparatus and allow to stand at a temperature equal to or higher than room temperature for 30 minutes or longer. Alternatively, it is preferable to fill the supply tubes 9 with a cleaning liquid for a liquid ejecting apparatus and allow to stand at 60° C. or higher for 10 minutes or longer. Such standing can result in a state in which air bubbles are unlikely to remain on the inner surfaces of the supply tubes 9, thereby further enhancing dischargeability of air bubbles. Accordingly, ejection failure of ink due to air bubbles can be suppressed further. Moreover, by setting the temperature to 60° C. or higher, the time for modifying the inner surfaces of the supply tubes 9 can be shortened.

Since the printer 1 includes the ultrasonic vibration mechanism 11 for applying ultrasonic vibration to ink in the supply tubes 9, ultrasonic vibration can be applied to ink in the liquid channels during the initial filling, and thus remaining air bubbles on the wall surfaces of the liquid channels can be reduced by the ultrasonic vibration. Accordingly, ejection failure of ink can be suppressed. Such an ultrasonic vibration mechanism is not limited to the configuration in which ultrasonic vibration is applied to ink in the supply tubes 9. Any configuration may be employed, provided that ultrasonic vibration can be applied anywhere inside liquid channels of a printer.

The printer 1 can also include an air bubble trapping mechanism. This can suppress ejection failure of ink. Further, the printer 1 may be configured to change the frequency of the flushing operation preceding the printing operation in accordance with the time that has elapsed since the initial filling, or to perform the timer cleaning operation. Such configurations can also suppress ejection failure of ink. Moreover, two or more of the above configurations can be combined. In other words, the printer 1 having at least one of the configurations of Examples 3 to 6 can employ the cleaning liquid for a liquid ejecting apparatus of Example 1 or 2, and/or can be combined with the supply tubes 9, a state of the inner surfaces of which is modified by any one of the methods of Examples 8 to 11. For example, in Example 4, the timer cleaning operation can also be performed during standing after filling with ink while applying ultrasonic microvibration. In this case, air bubbles can be discharged further since air bubbles adhering to the inner walls of the channels can be released by ultrasonic microvibration, and the released air bubbles can be discharged by the timer cleaning operation.

The cleaning liquid for a liquid ejecting apparatus is not limited to being used for the supply tubes 9 that are yet to be installed in the printer 1. For example, a configuration can also be employed in which a printer includes a tank for storing a cleaning liquid for a liquid ejecting apparatus and feeds the cleaning liquid for a liquid ejecting apparatus into a series of liquid channels in the printer before initial filling with ink. In this case, the state of the liquid channels filled with the cleaning liquid for a liquid ejecting apparatus may be maintained for a predetermined time by covering the nozzles with a cap, for example. Moreover, a heater or the like for warming liquid channels filled with a cleaning liquid for a liquid ejecting apparatus, may be included. Further, during a period after the manufacture of the printer 1 until initial filling with ink, a series of liquid channels in the printer can be filled with a cleaning liquid for a liquid ejecting apparatus.

In each of the above-mentioned embodiments, a piezoelectric element that causes a change in pressure of ink in the pressure chamber 30 is described as a flexural vibration-mode piezoelectric element but embodiments are not limited thereto. For example, a longitudinal vibration mode piezoelectric element, a heating element, or various actuators, such as an electrostatic actuator that changes the volume of pressure chambers by utilizing an electrostatic force, for example, can be employed. Further, the recording head 3 is described as a line head in which a plurality of the liquid ejecting units 4 are aligned in the width direction of the recording medium 2 but embodiments are not limited thereto. The invention is also applicable to a serial head that ejects ink while performing scanning (reciprocating movement) in a direction (main scanning direction) intersecting the transport direction (sub-scanning direction) of a recording medium and to a printer equipped therewith.

In the foregoing, the printer 1 equipped with the ink jet recording head 3 is described as an example of a liquid ejecting apparatus. The invention is, however, also applicable to other liquid ejecting apparatuses. For example, the invention is also applicable to, for example, a coloring material ejecting apparatus for manufacturing a color filter for a liquid crystal display and the like; an electrode material ejecting apparatus for forming an electrode of an organic electroluminescent (EL) display, a field emission display (FED), and the like; and an organic biomaterial ejecting apparatus for manufacturing a biochip (biochemical element). The coloring material ejecting apparatus for manufacturing a display ejects solutions of respective coloring materials of red (R), green (G), and blue (B) as a type of liquid. The electrode material ejecting apparatus for forming an electrode ejects a liquid electrode material as a type of liquid, whereas the organic biomaterial ejecting apparatus for manufacturing a biochip ejects a solution of an organic biomaterial as a type of liquid.

The entire disclosure of Japanese Patent Application No.2017-049696, filed Mar. 15, 2017 is expressly incorporated by reference herein.

What is claimed is:

1. A cleaning liquid for a liquid ejecting apparatus to be fed into a liquid channel of the liquid ejecting apparatus, the cleaning liquid comprising:
at least a water-soluble organic solvent, a silicone surfactant, and an acetylenic diol surfactant.

2. The cleaning liquid for a liquid ejecting apparatus according to claim 1, wherein at least part of an inner surface of the liquid channel is made from a fluorine-based material.

3. The cleaning liquid for a liquid ejecting apparatus according to claim 1, wherein an amount of dissolved nitrogen (N₂) is 5 ppm or less.

4. A liquid ejecting apparatus comprising a liquid channel, at least part of an inner surface of which is made from a fluorine-based material, wherein
a cleaning liquid for a liquid ejecting apparatus, the cleaning liquid containing at least a water-soluble organic solvent, a silicone surfactant, and an acetylenic diol surfactant, is fed into the liquid channel, and a state of the inner surface is modified.

5. The liquid ejecting apparatus according to claim 4, further comprising an ultrasonic vibration mechanism that applies ultrasonic vibration to a liquid in the liquid channel.

6. A cleaning method for a liquid channel of a liquid ejecting apparatus, the cleaning method comprising:
feeding a cleaning liquid for a liquid ejecting apparatus, the cleaning liquid containing at least a water-soluble organic solvent, a silicone surfactant, and an acetylenic diol surfactant, into the liquid channel.

7. The cleaning method according to claim 6, wherein the liquid channel is filled with the cleaning liquid for a liquid ejecting apparatus and is left to stand at a temperature equal to or higher than room temperature for 30 minutes or longer.

8. The cleaning method according to claim 6, wherein the liquid channel is filled with the cleaning liquid for a liquid ejecting apparatus and is left to stand at a temperature equal to or higher than 60° C. for 10 minutes or longer.
